(19) United States
(12) Patent Application Publication
(10) Pub. No.: US 2025/0158172 A1
(43) Pub. Date: May 15, 2025

(54) Multi-layered protective element for a battery

(71) Applicant: Henkel AG & Co. KGaA, Duesseldorf (DE)

(72) Inventors: Stefan Otte, Göttingen (DE); Roger Calixto de Araujo, Köln (DE); Mathias Jaehnichen, Dielheim (DE); Carsten Bonk, Duesseldorf (DE); Tim Froehlich, Duesseldorf (DE)

(21) Appl. No.: 19/019,660

(22) Filed: Jan. 14, 2025

Related U.S. Application Data
(63) Continuation of application No. PCT/EP2023/069893, filed on Jul. 18, 2023.

(30) Foreign Application Priority Data
Jul. 25, 2022 (EP) 22186613.0

(51) Int. Cl. H01M 10/658; B32B 5/02; B32B 5/26; D04H 1/08; D04H 1/42; F16L 59/02; H01M 50/209; H01M 50/242; H01M 50/291; H01M 50/293

(52) U.S. Cl. CPC H01M 10/658; B32B 5/022; B32B 5/266; D04H 1/08; D04H 1/42; F16L 59/026; H01M 50/209; H01M 50/242; H01M 50/291; H01M 50/293; B32B 2250/20; B32B 2262/08; B32B 2264/1026; B32B 2307/304; B32B 2457/10; B32B 2571/00; D10B 2211/02; D10B 2505/00

(57) ABSTRACT

The invention relates to a multi-layered protective element (20) for a battery (1) with at least two battery cells (10), which are arranged next to one another, wherein the protective element (20) can be arranged between the battery cells (10), and wherein the protective element (20) has a compressible core layer (21). According to the invention, the core layer (21) predominantly comprises animal wool and the layer thickness of the core layer is 60 to 98% of the total thickness of the protective element. The invention also relates to a battery (1) and to the use of the protective element (20) for a battery (1).

### DESCRIPTION

The invention relates to a multi-layered protective element for a battery with at least two battery cells. The invention also relates to a battery having the multi-layered protective element and to the use of the protective element as an intermediate layer between two battery cells.

### BACKGROUND

U.S. Pat. No. 10,840,494 B2 discloses a battery having a plurality of prismatic battery cells in the form of flat cuboids which are arranged adjacent to each other on their larger side surfaces. Starting from an uncharged state, the individual battery cells expand during charging, wherein the thickness of the individual battery cell, i.e., the distance between the two larger side surfaces, increases. The expansion of the individual battery cells arranged next to each other adds up to an overall expansion of the battery, which can result in problems. For example, if the battery cells are accommodated in a battery housing, the battery housing may become plastically deformed and possibly damaged due to the expansion of the individual battery cells. According to U.S. Pat. No. 10,840,494 B2, to compensate for the expansion of the battery cells, the protective element arranged between two adjacent battery cells has a compressible core layer. When the battery cells expand, this core layer is compressed so that the total thickness of the battery pack, consisting of the individual battery cells and the protective elements arranged therebetween, practically does not change when the battery is charged. Plastics material having a comparatively low Shore hardness is proposed as the material for the core layer.

In addition to compensating for the expansion of the battery cells, the protective element must also fulfill a thermal and electrical shielding function. Lithium-ion batteries in particular are highly unstable due to their chemical composition. For example, a local short circuit between the internal electrodes of a battery cell leads to a strong short-circuit current, which quickly heats up the battery cell in question to an extreme degree. This thermal runaway of a battery cell can easily or quickly spread to neighboring battery cells. This leads to a chain reaction, wherein the energy stored in the battery is explosively released. This explosive release of energy can be accompanied by toxic gases and the formation of flames and sparks. Therefore, the protective element should have low thermal conductivity, high dielectric strength and high thermal (fire) resistance.

Also, batteries and their components should be easy to recycle. When disposing of a used battery, a multi-layered protective element can possibly be separated from a battery cell for recycling, but if the individual layers of the protective element are made of different plastics materials, the protective element cannot be recycled in an environmentally friendly manner.

### SUMMARY OF THE INVENTION

The invention is therefore based on the object of providing a protective element for a battery which is compressible and heat-insulating, has high dielectric strength and is as environmentally friendly as possible.

The object of the invention is achieved by the combination of features according to claim 1. Exemplary embodiments of the invention can be found in the dependent claims of claim 1.

According to the invention, the compressible core layer predominantly comprises animal wool. Sheep's wool is used in a preferred exemplary embodiment. Using wool for the compressible core layer allows for providing protective elements (also known as battery compression pads) that can be easily compressed and have good compression behavior, on the one hand. On the other hand, very good thermal insulation can be achieved with low thermal conductivities below 0.05 W/mK. Moreover, using wool is environmentally friendly. Wool is a natural and renewable product and is easy to recycle. For example, used sheep's wool can be used as fertilizer.

Other types of animal wool besides sheep's wool include angora wool, mohair wool, cashmere wool and alpaca wool.

The proportion of wool in the core layer can be up to 100%. For example, the core layer can consist of up to 80%, 90% or even 100% wool. Preferably, the proportion of wool in the core layer is in a range of from 60% to 100%, particularly preferably in a range of from 80% to 100%. The core layer can be a nonwoven material having a plurality of layers that are placed or folded one upon the other. The core layer can also be made by felting. Felting makes use of the ability of wool threads to interlock. Pure new wool, in particular, is flame-retardant and has excellent thermal insulation values. It is also possible for the wool core layer to be composed of different sublayers. For example, the core layer may comprise a first nonwoven layer and a second nonwoven layer as well as a felt layer arranged between the two nonwoven layers.

The core layer can have a basis weight of from 80 to 1800 g/m². Preferred basis weights are between 100 and 1000 g/m² or even between 200 and 800 g/m².

According to the invention, the total thickness of the protective element is largely determined by the layer thickness of the core layer. The thickness of the core layer is 60% to 98% of the total thickness of the protective element.

The total width of the protective element may be from 0.5 to 12 mm. In one exemplary embodiment, this total thickness is 1.0 to 10.5 mm. The tolerance is preferably in a range of from +/−0.01 mm to +/−1 mm. According to the invention, a layer thickness of the compressible core layer (in the unloaded state) is 60% to 98% of the total thickness of the protective element and, in a preferred exemplary embodiment, is in a range between 1.5 mm and 10 mm. The tolerance is preferably in a range of from +/−0.01 mm to +/−1 mm.

The multi-layered protective element can have at least a first barrier layer, which preferably comprises mica. Mica is heat resistant and fireproof. Mica does not refer to a single specific mineral, but to a group of minerals, the so-called mica group, which have in common their chemical composition and crystal lattice structure.

The protective element can have a second barrier layer, wherein the core layer may be arranged between the two barrier layers. One of the two thermal barrier layers can constitute a first outer layer of the protective element.

A second outer layer of the protective element can be formed by an adhesive layer. This adhesive layer may comprise a protective release liner that must be removed before bonding to a battery cell. If the first outer layer is not designed to be adhesive, the individual battery cells can be laminated on one side with the second outer layer of the protective element during battery manufacture. Since the first outer layer is not designed to be adhesive, the battery cells, each provided with a protective element, can be arranged next to each other as a package and only then precisely aligned with each other.

A further object of the invention, namely the provision of a reliable, safe and environmentally friendly battery, is achieved with claim 9. Accordingly, a battery having at least two battery cells is proposed, between which a multi-layered protective element according to one of claims 1 to 8 is arranged. The protective element can have designs as provided for in the present disclosure. At least one of the battery cells can have a prismatic basic shape and preferably a cuboid basic shape. The battery cell can also be designed as a pouch. Preferably, all battery cells of the battery have the prismatic basic shape. In one exemplary embodiment, all battery cells are designed as pouches.

Moreover, the invention proposes the use of a multi-layered protective element according to one of claims 1 to 8 as an intermediate layer between two battery cells of a battery.

### BRIEF DESCRIPTION OF THE DRAWINGS

The invention is explained in more detail with reference to the exemplary embodiments shown in the drawings, in which:

FIG. 1 schematically shows a battery having a plurality of battery cells and a plurality of protective elements between the battery cells; and

FIG. 2 shows, by way of example, the layered structure of a protective element.

### DESCRIPTION OF EXEMPLARY EMBODIMENTS

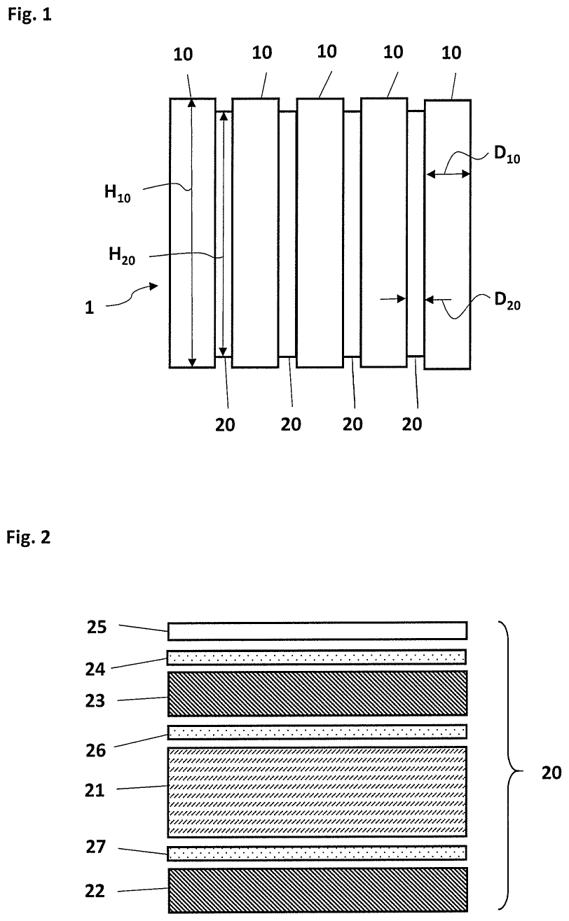

FIG. 1 schematically shows a battery which is denoted overall by 1. The battery may be, for example, a battery used for powering an electric vehicle.

The battery 1 comprises a plurality of battery cells 10. FIG. 1 shows five battery cells 10; the battery 1 may have fewer battery cells or more battery cells (for example ten battery cells). Each battery cell 10 has a cuboid basic shape. A height H₁₀ of each battery cell 10 can, for example, be 50 to 200 mm. A width which extends into the drawing plane in the representation of FIG. 1 can, for example, assume values between 50 and 300 mm. A thickness of the battery cell 10 is designated with D₁₀ and can be, for example, 10 to 50 mm.

A protective element 20 is arranged between each two adjacent battery cells 10. A thickness D₂₀ of each protective element 20 is 3 to 8 mm in preferred embodiments. The spatial extension of the protective element 20 (height and width) can correspond to the spatial extension of the battery cell 10. In the exemplary embodiment of FIG. 1, the height H₂₀ of the protective element 20 is slightly smaller than the height H₁₀ of the battery cell 10.

FIG. 2 shows the layered structure of the protective element 20. For the sake of clarity, the individual layers of the multi-layered protective element 20 are shown spaced apart from one another. Like FIG. 1, FIG. 2 also is not a scale drawing.

The protective element 20 has a compressible core layer 21 made of sheep's wool. The core layer 21 is arranged between a first barrier layer 22 and a second barrier layer 23, each comprising mica. The first barrier layer 22 is a first outer layer of the protective element 20.

The second barrier layer 23 lies between the core layer 21 and an adhesive layer 24 which comprises a release liner 25. The adhesive layer 24 (having the release liner 25) forms a second outer layer of the protective element 20. Further adhesive layers 26, 27 are provided between the barrier layers 22, 23 and the core layer 21.

In order to glue the protective element 20 to a battery cell 10, the release liner 25 is peeled off so that the adhesive of the adhesive layer 24 is exposed and the adhesive layer 24 can be placed on the relevant battery cell 10. The battery cell 10 and the protective element 10 adhering thereto then form a unit, which can then be arranged next to one another in the package/stack with other units produced in this way. Since the outer surfaces of each unit are non-adhesive, the units can still be aligned with each other even when they are already in the package or stack.

### LIST OF REFERENCE SIGNS

1 Battery
10 Battery cell
20 Protective element
21 Core layer
22 First barrier layer
23 Second barrier layer
24 Adhesive layer
25 Release liner
26 Adhesive layer
27 Adhesive layer

1. A multi-layered protective element (20) for a battery (1) with at least two battery cells (10), which are arranged next to one another, wherein the protective element (20) can be arranged between the battery cells (10), and wherein the protective element (20) has a compressible core layer (21), characterized in that the core layer (21) predominantly comprises animal wool and in that layer thickness of the core layer (21) is 60% to 98% of total thickness of the protective element (20).

2. The protective element (20) according to claim 1, wherein the wool in the core layer (21) is present in an amount in a range of from 60% to 100%.

3. The protective element (20) according to claim 1, wherein the core layer (21) comprises sheep's wool.

4. The protective element (20) according to claim 1, wherein the core layer (21) is a nonwoven material or a felt made of wool.

5. The protective element (20) according to claim 1, wherein the core layer (21) has a basis weight of from 200 to 1000 g/m².

6. The protective element (20) according to claim 1, wherein a first barrier layer (22) is provided, optionally comprising mica.

7. The protective element (20) according to claim 6, wherein a second barrier layer (23) is provided, such that the core layer (21) is arranged between the first barrier layer (22) and the second barrier layer (23).

8. The protective element (20) according to claim 7, wherein one of the two thermal barrier layers (22, 23) is a first outer layer of the protective element (20).

9. The protective element (20) according to claim 1, wherein a second outer layer is formed by an adhesive layer (24) having a release liner (25).

10. The protective element (20) according to claim 1, wherein the core layer (21) has a basis weight of from 200 to 1000 g/m² and comprises a nonwoven material or a felt comprising sheep's wool.

11. The protective element (20) according to claim 10, wherein a first barrier layer (22) and a second barrier layer (23) provided, such that the core layer (21) is arranged between the first barrier layer (22) and the second barrier layer (23).

12. The protective element (20) according to claim 11, wherein the first barrier layer (22) and the second barrier layer (23) comprise mica such that each is a thermal barrier layer.

13. The protective element (20) according to claim 12, wherein one of the two thermal barrier layers (22, 23) is a first outer layer of the protective element (20).

14. The protective element (20) according to claim 13, wherein a second outer layer is formed by an adhesive layer (24) having a release liner (25).

15. A battery (1) comprising:
at least two battery cells (10), and
the protective element (20) according to claim 1 arranged between the at least two battery cells.

16. The battery of claim 15, wherein the protective element (20) further comprises a second barrier layer (23), such that the core layer (21) is arranged between the first barrier layer (22) and the second barrier layer (23).

17. A method of providing thermal and/or electrical shielding between two battery cells (10), which are arranged next to one another in a battery, by interposing the protective element (20) according to claim 1 between the two battery cells (10) of the battery (1).
